(19) United States
(12) Patent Application Publication
(10) Pub. No.: US 2008/0130553 A1
(43) Pub. Date: Jun. 5, 2008

(54) Electronic apparatus and wireless connection control method

(75) Inventor: Kei Takahashi, Oume-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/790,784

(22) Filed: Apr. 27, 2007

(30) Foreign Application Priority Data
Nov. 30, 2006 (JP) 2006-324802

(51) Int. Cl. H04Q 7/00

(52) U.S. Cl. 370/328

(57) ABSTRACT

According to one embodiment, an electronic apparatus includes a wireless communication section, a wired connection section, an association processor, a storage section, an updating section and an authentication processor. Through the wireless communication section, a wireless connection with a host is established. Through the wired connection section, a wired connection with the host is established. The storage section stores setup information of the permission for the wireless connection with the host for which the association process has been completed by the association processor. The updating section receives a request to transmitting the setup information from the host, transmits the setup information to the host in response to the request and updates the setup information by employing updated setup information transmitted by the host. The authentication processor authenticates the wireless connection based on the setup information.

### CROSS-REFERENCE TO RELATED APPLICATIONS

This application is based upon and claims the benefit of priority from Japanese Patent Application No. 2006-324802, filed Nov. 30, 2006, the entire contents of which are incorporated herein by reference.

### BACKGROUND

1. Field

One embodiment of the invention relates to an electronic apparatus having a wireless communication function, and a wireless connection control method employed by the apparatus.

2. Description of the Related Art

To date, a great variety of portable laptop and notebook personal computer types have been developed that are equipped, to expand their available functions, with externally accessible connection ports, such as those for universal serial bus (USB) or IEEE 1394 interfaces. These connection ports are provided to permit connections to computers of various electronic peripheral apparatuses, including storage devices and printers.

However, an arrangement whereby cables are used to connect electronic apparatuses to a portable personal computer may detract from the portability of the computer.

Therefore, a new short-distance wireless system, such as the wireless USB standard, has recently been developed. When the wireless USB standard is employed for connection, an authentication process called an association process is required to permit connection of apparatuses that have been authenticated. For example, as disclosed in JP-A-2003-114789, for connecting a client terminal to a predetermined host computer, only a client terminal that is permitted to connect is employed.

However, in an environment wherein various electronic apparatuses are wirelessly connected to a computer, an electronic apparatus owned by a specific user might be accessed by a computer of an unauthorized user through wireless communication.

According to the wireless USB standard, a cable association model is defined as procedures for correlating a wireless USB host with a wireless USB device. Once a wireless USB device is connected to a wireless USB host via a cable, wireless communication can be initiated between the wireless USB host and the wireless USB device.

As another problem, when a plurality of wireless USB hosts for which association has been completed are present for a single wireless USB device, a connection destination can not be designated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the functional configuration of an electronic apparatus according to one embodiment of the present invention;

FIG. 2 is an exemplary block diagram showing the hardware arrangement of the host of the embodiment;

FIG. 3 is an exemplary block diagram showing the hardware arrangement of the electronic apparatus of the embodiment;

FIG. 4 is an exemplary diagram for explaining an overview of an updating process for changing the setup information performed in the embodiment;

FIG. 5 is an exemplary schematic diagram showing example setup information; and

FIG. 6 is an exemplary flowchart showing a wireless connection control process employing the electronic apparatus of the embodiment.

### DETAILED DESCRIPTION

One embodiment of the present invention will now be described while referring to drawings.

Various embodiments according to the invention will be described hereinafter with reference to the accompanying drawings. In general, according to one embodiment of the invention, an electronic apparatus includes a wireless communication section, a wired connection section, an association processing section, a storage section, a receiving section, a transmitting section, an updating section and an authentication processing section. The wireless communication section performs a wireless communication with a host. Through the wired connection section, a wired connection with the host is established. The association processing section performs an association process with the host to share a common key via the wired connection. The storage section stores setup information indicating whether or not an establishment of the wireless connection with the host for which the association process has been completed is permitted. The updating section receives a setup information transmission request sent by the host, transmits the setup information to the host in response to the setup information transmission request and updates the setup information stored in the storage section by employing updated setup information sent by the host. The authentication processing section that authenticates the establishment of the wireless connection with the host based on the setup information.

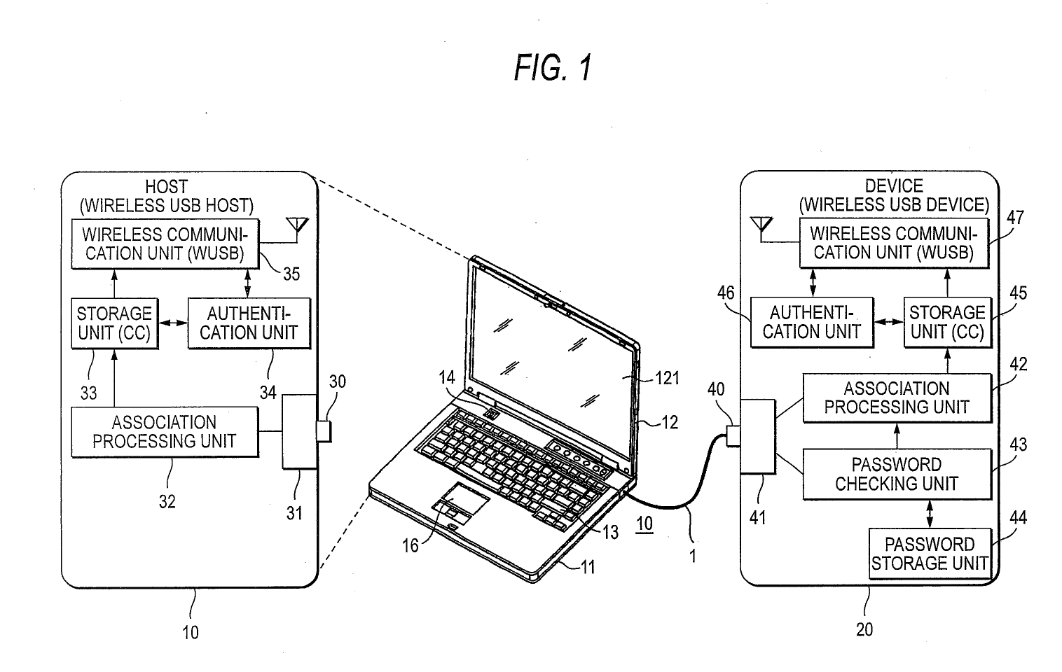

First, the functional configuration of an electronic apparatus according to the embodiment of the invention will be described while referring to FIG. 1.

FIG. 1 is an exemplary block diagram showing the functional configuration of an electronic apparatus according to one embodiment of the present invention.

The electronic apparatus is provided as a device 20 that performs wireless communication with a host, and serves, for example, as a wireless USB device that performs wireless communication in accordance with a wireless USB standard. The device 20 includes a peripheral apparatus, such as a storage device or a printer, or an adaptor called a device wired adaptor (DWA). The DWA is an adaptor (a hub) for connecting a conventional wired USB device to a wireless USB host.

A host 10 has a wireless communication function, and serves as a wireless USB host. The host 10, for example, is a portable personal computer.

By employing wireless USB, a wireless USB host can perform wireless communication with a maximum 127 wireless USB devices.

The device 20 includes a conventional wired USB interface through which wired connection to a host is established and a wireless USB through which a wireless connection to a host is established.

The device 20 includes: a connection port 40, a wired USB interface 41, an association processing unit 42, a password checking unit 43, a password storage unit 44, a storage unit 45, an authentication unit 46 and a wireless communication unit 47.

The connection port 40 is a USB connector, and the wired USB interface 41 performs wired communication with the host 10 via a USB cable 1. When the wired connection is established between the device 20 and the host 10, the association processing unit 42 performs an association process using a cable association model. This association process is required for the host 10 and the device 20 to use an inherent key in common (common key), and is performed while a wired connection is established between the host 10 and the device 20 via the USB cable 1. This association process is also performed when the connection port 40 of the device 20 is physically connected to a connection port 30 of the host 10.

Specifically, during the association process, the host 10 and the device 20 perform data communication via the wired connection, i.e., the host 10 distributes connection information called connection contents (CC) to the device 20, which stores the CC received from the host 10 in the storage unit 45. Further, the information for a host 10 for which the association process has been completed is stored as setup information in the storage unit 45. The setup information includes a list of a plurality of hosts 10 for which the device 20 has performed the association process, and also includes information, which will be described later, indicating whether connection to the individual hosts 10 is permitted or prohibited.

CC is information that indicates a correlation between a host 10 and a device 20, and shared by the host 10 and the device 20. The CC includes: a CHID (a Connection Host ID), which is an ID for identifying a host 10; a CDID (a Connection Device ID), which is an ID for identifying a device 20; and a CK (a Connection Key). The CK (Connection Key) is the above described inherent key and is used in common by a host 10 and a device 20 to establish a wireless connection securely between them. CC is generated for each of combinations between each of the hosts 10 and a device 20. When a device 20 has performed the association process for multiple hosts 10, a plurality of CCs will be stored in the storage unit 45.

Once the association process has been performed between a device 20 and a specific host 10, a wireless connection between the host 10 and the device 20 can be established without a wired connection via a cable 1.

Generally, the association process is automatically performed when a device 20 is connected to a host 10 via a USB cable 1. Thus, if a wired connection is established between a device 20 and the computer of an unauthorized user, the unauthorized user would thereafter be able to use his or her computer to wirelessly access the device 20.

Therefore, in this embodiment, the password checking unit 43 and the password storage unit 44 are included in the device 20 to prevent an indefinite unauthorized performance of the association process.

Then, when a password (an association password) is present in the password storage unit 44, the association process is not performed until the password checking unit 43 has completed a password checking process. During the password checking process, the password checking unit 43 compares the association password with a password transmitted by the host 10, via the USB cable 1, to determine whether the two match. When the passwords match, the password checking unit 43 permits the association processing unit 42 to perform the association process, whereas if a match is not obtained, the password checking unit 43 prevents the association processing unit 42 from performing the association process. This password checking process is not performed, however, unless an association password is present in the password storage unit 44.

Thus, at the time a device 20 is installed and is connected to the computer of an owner by a USB cable 1, the owner should immediately employ a special utility program to set an association password. Failure to do so could compromise the security of the device 20 and facilitate its unauthorized employment by other persons.

When the wireless communication unit 47 detects a host 10 with which a wireless connection can be established, the authentication unit 46 performs an authentication process to determine whether the same key (CK) is used, in common, by the detected host 10 and the device 20, i.e., whether the detected host 10 and the device 20 are employing the same CC. And when it is determined that the detected host 10 and the device 20 are using the same key (CK), the authentication unit 46 permits the initiation of wireless communication between the detected host 10 and the wireless communication unit 47. In this case, data to be exchanged by the detected host 10 and the device 20 are encrypted using an encryption key generated by employing the CK in the authentication process. However, when the detected host 10 and the device 20 do not share the same key (CK), the authentication unit 46 inhibits the initiation of wireless communication between the detected host and the wireless communication unit 47.

Furthermore, the authentication unit 46 employs the setup information in the storage unit 45 to determine whether the device 20 should or should not be permitted to connect to individual hosts 10 for which the association process has been completed.

The wireless communication unit 47 is a wireless communication module for performing wireless communication with a wireless USB host in accordance with the wireless USB standard.

The host 10 includes: a main body 11 and a display unit 12 mounted on the main body 11. A liquid crystal display device (LCD) 121 is incorporated in the display unit 12, while a keyboard 13, a power button 14 and a touch pad 16 are arranged across the upper face of the main body 11.

The host 10 includes a conventional wired USB interface through which wired connection the device 20 is established and a wireless USB through which a wireless connection with the device 20 is established.

That is, the host 10 includes: the connection port 30, a wired USB interface 31, an association processing unit 32, a storage unit 33, an authentication unit 34 and a wireless communication unit 35.

The association unit 32 employs the above described cable association model to perform an association process relative to a device (a wireless USB device) that is connected by wire to the host 10. During the association process, the association processing unit 32 generates CC information (including a CHID, a CDID and a CK) inherent to the host 10 and the device 20, and transmits the CC to the device 20 and stores it in the storage unit 33.

Then, when the wireless communication unit 35 receives a wireless connection request from the device 20, the authentication unit 34 performs an authentication process to determine whether the device 20 and the host 10 share a key (CK), i.e., whether the host 10 and the device 20 are employing the same CC. And when it is determined that the same key (CK) is being employed, in common, by the host 10 and the device 20, the authentication unit 34 permits the establishment of wireless connection between them.

The wireless communication unit 35 is a wireless communication module that performs wireless communication with a wireless USB device in accordance with the wireless USB standard.

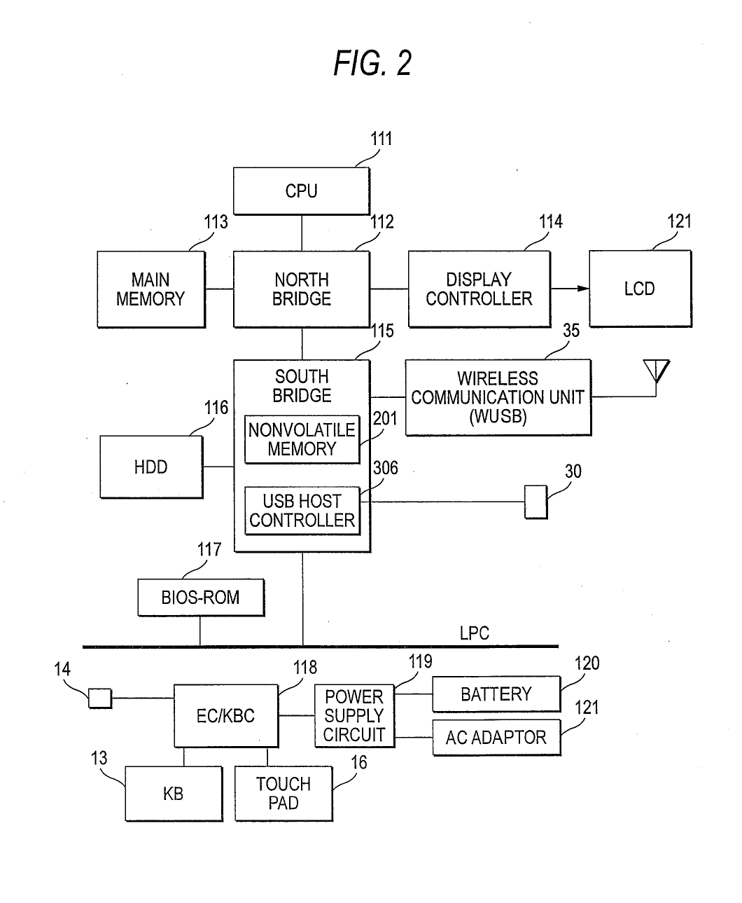

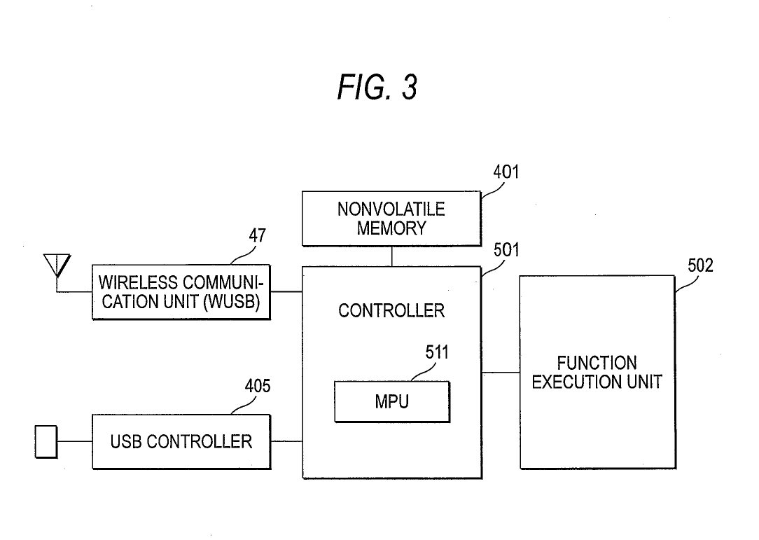

The hardware arrangements of the host 10 and the device 20 will be described while referring to FIGS. 2 and 3, respectively.

FIG. 2 is an exemplary diagram showing an example hardware arrangement of the host 10.

The host 10 includes: a CPU 111, a north bridge 112, a main memory 113, a display controller 114, a south bridge 115, a hard disk drive (HDD) 116, a BIOS-ROM (117), an embedded controller/keyboard controller IC (EC/KBC) 118 and a power supply circuit 119.

The CPU 111 is a processor that controls the operation of the individual components of the host 10. The CPU 111 executes the software for an operating system and various application programs/utility programs, which are loaded into the main memory 113 from the HDD 116, and also executes a BIOS stored in the BIOS-ROM 117.

The north bridge 112 is a bridge device that connects the local bus of the CPU 111 to the south bridge 115. The north bridge 112 also communicates with the display controller 114, via an AGP (Accelerated Graphics Port) bus, and includes an incorporated memory controller that controls the main memory 113.

The display controller 114 controls the LCD 121 used as the display monitor for the host 10. The wireless communication unit 35 is connected, via a PCI (Peripheral Component Interconnect) bus, to the south bridge 115, into which are incorporated a nonvolatile memory 201 and a USB host controller 306.

The embedded controller/keyboard controller IC (EC/KBC) 118, which is connected to an LPC (Low Pin Count) bus, is a one-chip micro computer formed by integrating an embedded controller that controls power source management and a keyboard controller that controls a keyboard (KB) 13 and a touch pad (mouse) 16.

In response to user manipulation of a power button 14, the embedded controller/keyboard controller ILC 118, in cooperation with the power source circuit 119, turns on or off the host 10. The power source circuit 119 employs power supplied by either a battery 120 or an external power source, through an AC adaptor 121, to generate power to be fed to the individual components of the host 10.

FIG. 3 is an exemplary diagram showing an example hardware arrangement of the device 20.

The device 20 includes: the above described wireless communication unit 47, nonvolatile memory 401, a USB controller 405, a controller 501 and a function execution unit 502.

The controller 501 incorporates an MPU 511, which controls the wireless communication operations both of the wireless communication unit 47 and of the USB controller 405. The MPU 511 also performs the association process, the password checking process and the authentication process described above.

The association process, the password checking process and the authentication process may also be performed by hardware.

The function execution unit 502 enables the device 20 to serve as a peripheral device, such as a storage device or a printer, or a DWA.

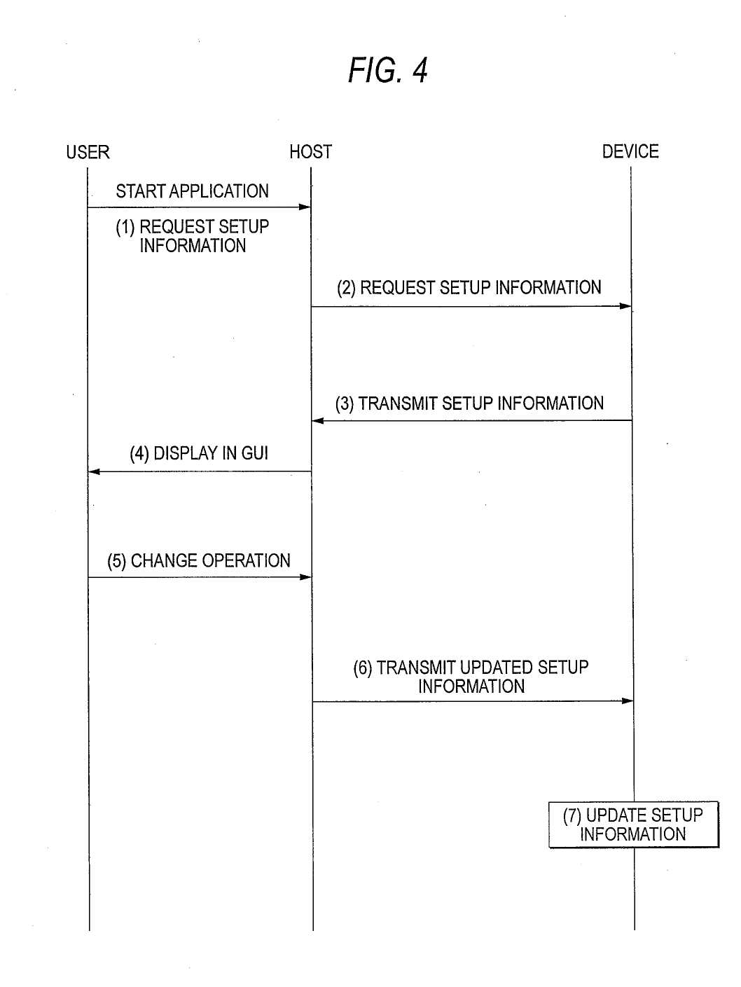

An overview of the processing performed to change the setup information (an updating process) employed for this embodiment will now be described while referring to FIG. 4.

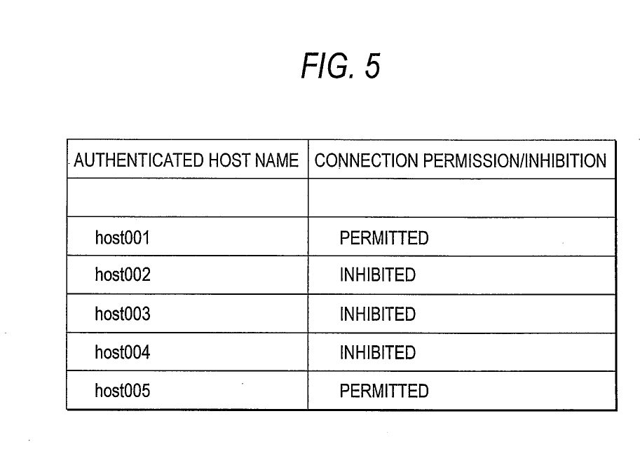

First, as shown in FIG. 5, assume that a device 20 holds a list of hosts 10 for which the association process has been completed, and further assume that a host 10 holds a list of devices 20 for which the association process has been completed.

(1) A user starts a special application, and issues an instruction to the host 10 to transmit a setup information transmission request to the device 20.

(2) The host 10 transmits the setup information transmission request to the device 20.

(3) Upon receiving the setup information transmission request, the device 20 reads setup information from the storage unit 45 (see FIG. 5) and transmits the setup information to the host 10.

(4) When the host 10 receives the setup information from the device 20, the host 10 displays the setup information, as shown in FIG. 5, using the GUI display of a special application.

(5) By manipulating the GUI of the special application, a user can change connection permissions or inhibitions for the individual hosts for which the association process has been completed. Further, as needed, the user can delete host names from the list of setup information.

(6) When the setup information has been changed, the host stores the new setup information in the storage unit 33, and then transmits the setup information to the device 20.

(7) The device 20 receives the new setup information, and updates the setup information stored in the storage unit 45 by employing the received setup information.

The updating process may also be performed by hardware.

According to this embodiment, since through the process the host 10 can designate a device 20 with which to establish a wireless connection, wireless USB can be used to efficiently connect the host 10 to a desired device.

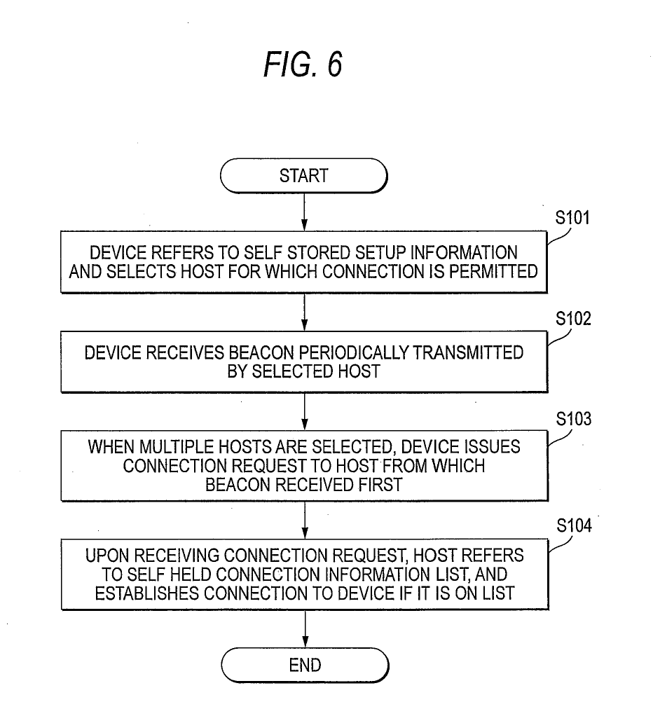

FIG. 6 is a flowchart showing a wireless connection control process employing the electronic apparatus of this embodiment.

The device 20 refers to self stored setup information and selects a host 10 for which connection is permitted (step S101). The device 20 also receives a beacon periodically output by the selected host 10 (step S102). When a plurality of hosts 10 are selected, the device 20 issues a connection request to the host 10 from which the device 20 received a beacon (step S103) first. Upon receiving the connection request, the host 10 refers to self stored connection information list and establishes a connection if the device 20 is on the list (authentication process: step S104).

The wireless connection control process may also be performed by hardware.

As described above, according to the embodiment, the wireless connection of a host 10 and a device 20 is established dependent on the performance of an authentication process that is based on setup information. Further, connection permission or inhibition, indicated by setup information, can also be arbitrarily designated by the host 10. In this case, a desired wireless USB device can selectively be provided for connection to a wireless USB host.

According to the embodiment, connection to a desired wireless USB host is enabled.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a wireless communication section that performs a wireless communication with a host;
a wired connection section through which a wired connection with the host is established;
an association processing section that performs an association process with the host to share a common key via the wired connection;
a storage section that stores setup information indicating whether or not an establishment of the wireless connection with the host for which the association process have been completed is permitted;
an updating section that receives a setup information transmission request sent from the host, transmits the setup information to the host in response to the setup information transmission request and updates the setup information stored in the storage section by employing updated setup information sent from the host; and
an authentication processing section that authenticates the establishment of the wireless connection with the host based on the setup information.

2. The electronic apparatus according to claim 1, wherein, the host comprises a plurality of hosts, and wherein, the setup information indicates whether or not the establishment of the wireless connection with each of the hosts is permitted.

3. The electronic apparatus according to claim 2, wherein, the updating section updates the setup information for each of the hosts.

4. The electronic apparatus according to claim 2, further comprising a wireless connection controlling section that sends a query to the host for the establishment of the wireless connection based on the setup information and establishes the wireless connection only with the one of the hosts that replies to the query first between the hosts.

5. A wireless connection control method for controlling an establishment of a wireless connection of an electronic apparatus to a host, the method comprises:
performing an association process for sharing the common key between the electronic apparatus and the host in a case where a wired connection therebetween have been established;
storing setup information indicating whether or not the establishment of the wireless connection between the electronic apparatus and the host for which the association process have been completed is permitted in a storage section of the electronic apparatus;
receiving a setup information transmission request sent from the host;
transmitting the setup information stored in the storage section to the host in response to the setup information transmission request;
updating the setup information stored in the storage section of the electronic apparatus by employing updated setup information sent from the host; and
authenticating the establishment of the wireless connection between the electronic apparatus and the host based on the setup information stored in the storage section.

6. The wireless connection control method according to claim 5, wherein, the host comprises a plurality of hosts, and
wherein, the setup information indicates whether or not the establishment of the wireless connection with each of the hosts is permitted.

7. The wireless connection control method according to claim 6, wherein, the setup information is updated for each of the hosts.

8. The wireless connection control method according to claim 6, further comprising:
sending a query for establishing the wireless connection from the electronic apparatus to the host based on the setup information; and
establishing the wireless connection only with the one of the hosts that replies to the query first between the hosts.
